(19) United States
(12) Patent Application Publication
(10) Pub. No.: US 2014/0122100 A1
(43) Pub. Date: May 1, 2014

(54) HEALTH PROVIDER QUALITY SCORING ACROSS MULTIPLE HEALTH CARE QUALITY DOMAINS

(71) Applicant: TREO SOLUTIONS, LLC, Troy, NY (US)

(72) Inventor: Herb FILLMORE, Blauvelt, NY (US)

(73) Assignee: Treo Solutions, LLC, Troy, NY (US)

(21) Appl. No.: 13/827,482

(22) Filed: Mar. 14, 2013

Related U.S. Application Data
(60) Provisional application No. 61/718,544, filed on Oct. 25, 2012.

(51) Int. Cl. G06Q 50/22

(52) U.S. Cl. CPC G06Q 50/22; G06Q 10/06395
USPC 705/2

(57) ABSTRACT

Evaluation of health care provider quality is described. Data is obtained, the data including claims data and member data of a member panel of a health care provider, the member panel including patients to which the provider provides health care services. Based on the obtained data, quality scores are determined for the provider across the member panel and across health care quality domains. A composite health provider quality score of the health provider is then determined, where the composite health provider quality score is a composite of the determined quality scores across the member panel and across the multiple health care quality domains. In some embodiments, risk-adjustment is performed for the quality scores, such as risk-adjustment against a peer reference base based on disease categories, patient age, and patient gender.

### BACKGROUND

Quality of service delivered by a health care provider is an important consideration for various stakeholders, including patient, providers, and health care plan(s) or other organizations with which the providers participate. A health care provider refers generally to any provider of health care services, and can encompass a broad range of entities, such as physician and/or non-physician health care practitioners, physician groups, facilities, health systems, and accountable care organizations, as examples. Determination of health care value to these stakeholders is dependent in part on the ability to evaluate and measure both cost of care and quality of care delivered by the health care provider. While cost and utilization of health care services have been traditional measures examined by payers, providers, and purchasers of care, the metrics for quality have not been as clear cut. There are arguably hundreds, or even thousands, of process-oriented or disease-specific quality measures. What is needed is a comprehensive, easy-to-view measure that offers a broad understanding of the quality of care and performance of a health care provider.

### BRIEF SUMMARY

The shortcomings of the prior art are overcome and additional advantages are provided through the provision of a method for evaluating health care provider quality. The method includes, for instance: obtaining data including health care claims data corresponding to health care claims by a member panel of a health care provider, the member panel comprising multiple patients to which the health care provider provides health care services; determining, based at least partially on the obtained health care claims data, quality scores for the health care provider across the member panel and across multiple health care quality domains, wherein a health care quality domain of the multiple health care quality domains comprises a heath status domain, wherein a determined quality score of the health status domain comprises a measure of disease progression in members of the member panel of the health care provider; and determining, by a processor, a composite health provider quality score of the health provider, the composite health provider quality score being a composite of the determined quality scores for the health care provider across the member panel and across the multiple health care quality domains.

Further, a computer system is provided for evaluating health care provider quality. The computer system includes a memory; and a processor in communication with the memory, and the computer system is configured to perform, for instance: obtaining data including health care claims data corresponding to health care claims by a member panel of a health care provider, the member panel comprising multiple patients to which the health care provider provides health care services; determining, based at least partially on the obtained health care claims data, quality scores for the health care provider across the member panel and across multiple health care quality domains, wherein a health care quality domain of the multiple health care quality domains comprises a heath status domain, wherein a determined quality score of the health status domain comprises a measure of disease progression in members of the member panel of the health care provider; and determining a composite health provider quality score of the health provider, the composite health provider quality score being a composite of the determined quality scores for the health care provider across the member panel and across the multiple health care quality domains.

Yet further, a computer program product is provided for evaluating health care provider quality. The computer program product includes a tangible storage medium readable by a processor and storing instructions for execution to perform a method that includes, for instance: obtaining data including health care claims data corresponding to health care claims by a member panel of a health care provider, the member panel comprising multiple patients to which the health care provider provides health care services; determining, based at least partially on the obtained health care claims data, quality scores for the health care provider across the member panel and across multiple health care quality domains, wherein a health care quality domain of the multiple health care quality domains comprises a heath status domain, wherein a determined quality score of the health status domain comprises a measure of disease progression in members of the member panel of the health care provider; and determining a composite health provider quality score of the health provider, the composite health provider quality score being a composite of the determined quality scores for the health care provider across the member panel and across the multiple health care quality domains.

Additional features and advantages are realized through the concepts of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one example of a process for determining a provider's quality score for a member experience health care quality domain, in accordance with one or more aspects of the present invention;

FIG. 2 depicts one example of a process for determining a provider's quality score for a primary/secondary prevention health care quality domain, in accordance with one or more aspects of the present invention;

FIG. 3 depicts one example of a process for determining a provider's quality score for a tertiary prevention health care quality domain, in accordance with one or more aspects of the present invention;

FIG. 4 depicts one example of a process for determining a provider's quality score for a population health status health care quality domain, in accordance with one or more aspects of the present invention;

FIG. 5 depicts one example of a process for determining a provider's quality score for a continuity of care health care quality domain, in accordance with one or more aspects of the present invention;

FIG. 6 depicts one example of a process for determining a provider's quality score for a chromic care and follow-up services health care quality domain, in accordance with one or more aspects of the present invention;

FIG. 7 depicts example plots indicating distribution of composite health provider quality scores for health care providers of a health care provider group, in accordance with one or more aspects of the present invention;

FIG. 8 depicts one example of a process for evaluating health provider quality, in accordance with one or more aspects of the present invention;

FIG. 9 depicts one example of a data processing system to incorporate and use one or more aspects of the present invention; and

FIG. 10 depicts one embodiment of a computer program product incorporating one or more aspects of the present invention.

### DETAILED DESCRIPTION

This invention relates to health care providers and more particularly to evaluating quality of the performance of health care providers using process and outcome measures, as examples.

The state of affairs in health care quality measurement can be described as either an embarrassment of riches or chaos. Many existing professional, governmental, and commercial entities have their own lists of structural, process, and outcome measures for determining health care quality. The majority of such measures are disease-specific and process-oriented.

Although process measures can sometimes, and to varying degrees, play a role in the improvement of health care delivery, too strong a focus on process measures can drastically deemphasize important outcomes. What is needed is an overall understanding of health provider and system performance, as well as a quantitative measure, such as a number, to aid in that understanding. Such a composite quantitative measure, termed a quality index score (also referred to as a composite quality index score or composite health provider quality score) is provided herein. It is additionally beneficial to examine the constituent parts of that composite score to determine the factors influencing it. For example, in the case of a total quality measure, it may be beneficial to determine in what area(s) the provider is excelling—for instance, in the provision of chronic care services, prevention services, etc.

Consideration of hundreds of disease-specific quality measures may not provide an effective and useful overview of the provider's quality. Furthermore, consideration of a large number of disparate disease specific measures that are aggregated into a composite does not provide a composite score that can be compared between providers for an “apples to apples” comparison. If a provider does not service a particular kind of patient, for instance, his or her composite score will not represent the same kind of care as the composite for someone who does serve that particular kind of patient.

To obtain a proper quantitative measure, aspects of the present invention adopt a whole-practice view of quality, emphasizing measures that can apply to all members of a health plan, network, group practice, or primary care provider panel. A member is the recipient of services provided by a health care provider. That member is said to be attributed (i.e. an “Attributed Member”) to a health care provider based on that health care provider providing services to the member.

According to aspects of the present invention, quality is measured across patient types, increasing its utility for “apples to apples” comparisons. Pouring through dozens of reports describing blood pressure, blood glucose testing, LDL levels, aspirin at discharge, and other process measures is tedious. Described herein is a methodology in which a relatively small number of key measures are used to efficiently, but effectively, demonstrate health provider value for dollars spent. In order to avoid adding to increasing health care costs, the methodology, in some embodiments, seeks valid measures derived from health care claims data to reduce administrative burden and gaming.

The advantages of new models for health care delivery, such as a medical home or accountable care program/organization (ACO), are most successfully reaped when the program has a complete understanding of the total health care costs and quality of care. Cost of care can be understood intuitively as the sum total of costs for services. It is possible to disaggregate costs into professional costs, ancillary costs, drug costs, and other types of costs, to better understand specific elements of those costs. In contrast, the concept of quality is sometimes less definite because of the numerous ways to define what is meant by quality of care and the numerous ways to measure it. One advantage of a composite health care provider quality index score described herein is that it provides a set of easy to comprehend, meaningful measures to compare quality—delivering valid information without overwhelming detail, yet leaving available the opportunity to drill down to individual measures where desired. In effect, the composite quality index score provides a clear view of the ‘forest’ that is health provider quality without hiding the ‘trees’.

A population-based composite quality index score is provided which offers a top line view of quality. A set of measures (quality scores) for multiple health care quality domains and across the member panel of a health care provider are synthesized into one composite quality index score for the health care provider that bridges patient conditions, processes, and outcomes to deliver a comprehensive view of quality of care. These measures are associated with provider behavior and amenable to changes by the provider. The amenability to changes is an important attribute of aspects described herein. Quality measures that cannot be influenced by the provider have little value in settings where the provider is trying to do better. The quality index score comprises a quantitative measure that represents a holistic overview of the quality of care rendered by a health care provider. It utilizes current health care claims data and identifies key measures that can be used to provide a quality perspective of the value for dollars spent, and enables one to drill down behind the composite quality index score to find specific opportunities for improvement.

The quality index score is a first step in examining the overall quality of care provided to a provider's patient population. It can offer, as an example, a road map for areas where attention and interventions may be necessary, and therefore is one resource that can be used by the involved parties to strengthen health care value and establish new and effective approaches to health care delivery and payment systems, such as medical homes and accountable care organizations.

As noted above, the quality index score is based on data taken across multiple health care quality domains that account for patient conditions, processes of care, and outcomes of care, as examples. Each health care quality domain can include measures that are influenced by changes in provider behavior. While each domain can be viewed on its own, the quality index score offers a composite, overall score that is used, in one example, to rank health care provider performance and to compare a provider's score to an overall average score for a health care system or network. Such score can facilitate pinpointing areas to emphasize in terms of performance improvement.

Also as noted above, the quality index score is based on data taken across the member panel for a provider and across a period of time. It should be understood that this does not necessarily mean that every single member of the provider panel is taken into account in determining every particular quality score that factors into the composite. There may be certain eligibility requirements for a particular member to be taken into account in determining a quality score of a domain. For instance, completion rate of breast cancer screening taken ‘across the member panel’ will consider only some female patients of the provider. Male patients and females under a particular cutoff age would not typically undergo such screening and therefore wouldn't be considered an eligible member to be taken into account along that metric. Similarly, some quality scores will be determined for patients within a particular age range. In that case, patients outside of that age range are not included in determining that quality score. ‘Across the member panel’ therefore does not necessarily imply that a statistic for every single member of the panel is included in the particular determination. Instead, a member, of the panel, that fits into the category of patients for which the determination applies will be factored into the determination.

Because, depending on the circumstances, there may be different goals and/or objectives for analyzing health care provider performance, the quality index is designed to be flexible. In one example, there are multiple core health care quality domains that may be equally or unequally weighted for purposes of determining the composite quality index score for a health care provider. Examples of such core domains include: member experience; primary and secondary prevention; tertiary prevention; population health status; continuity of care; and chronic and follow-up care. Additional domain(s), such as an efficiency measure, can be added as desired, for instance if goals of a particular client (a stakeholder commissioning the quality index scoring of the health care provider, for instance) so dictate. Measures additional to, or in place of, those discussed in connection with each of the individual domains can be included, with a focus on testing the reliability and validity of the score based on those changes.

The health care quality domains are populated by a plurality of metrics which include data taken across periods of time (for instance consecutive years) and for each member to which the provider being assessed provides services (i.e. each “attributed” member). In some examples, multiple metrics are used for a domain. Example metrics used as part of the examples provided herein can include (but are not limiting on the metrics or types thereof that can be used): well care and preventive screening data (using, for instance, widely used metrics in the health care industry, for example a Healthcare Effectiveness Data and Information Set (HEDIS) equivalent code); continuity of care (COC) (using, for instance, a validated measure, such as the COC index) that is risk-adjusted for the provider's member panel; degree of association between the provider and the member (i.e. strong, modest, weak); risk-adjusted ambulatory sensitive admissions and emergency department visits; follow-up after hospitalizations; risk-adjusted readmissions and physician visits for chronic conditions; and overall panel health status changes year over year (peer-compared and risk-adjusted), as examples.

Metrics used in determining the composite quality index score can rely on existing classification system(s), for instance system(s) offered by 3M® Health Information Systems for identifying preventable events (such as Potentially Preventable Readmissions (PPRs)), or other methodologies for identifying preventable events. Various methodologies exist that provide population-based morbidity measures, including Johns Hopkins University's Adjusted Clinical Group® (ACG), 3M® Health Information Systems' Clinical Risk Groups (CRGs), Diagnostic Cost Groups (DCGs), and Clinical Classification Software (CCS) developed by the federal Agency for Healthcare Research and Quality (AHRQ). Similarly, methodologies exist to identify potentially avoidable events such as emergency room visits, hospitalizations or readmissions, and ancillary services. These include 3M®'s Potentially Preventable Emergency Department Visits (PPVs), and Potentially Preventable Initial Admissions (PPAs) and Potentially Preventable Readmissions (PPRs).

Z-Score Determination:

The health care provider's member panel is, in one example, assessed for sufficient size and eligibility for specific metrics and domains. Then, the provider's performance may be scored and ranked among a larger peer reference base, such as a set of health care providers affiliated with a single health care system or network. In this regard, a statistically proven scoring methodology is adopted for measuring providers. In one example, the methodology uses standard scores (referred to herein as “z-scores”), a risk-adjusted expected compliance rate for the provider, and percent difference from the risk-adjusted expected compliance rate.

A z-score in this context represents a normalized quality performance score of a health care provider. It is a standardized measure of the number of deviations from a mean. Therefore, z-score can be thought of as the “distance” of a provider's performance from the mean of the peer reference group, i.e. all health care providers to which that provider is compared. It tells how “far” a provider is away from the mean, whether the score is below the mean (negative z-score) or above the mean (positive z-score), and represents a provider's ranking percentile within the population of providers. Z-scores have an average of 0 and might typically range from −3 to 3 in the QIS measures, depending, of course, on the amount of variation in performance.

A panel-weighting methodology is used for z-score calculations based on the size of the member panel of a health care provider, in order to prevent the overall roll-up performance of a group of providers (such as an accountable care organization or a health care provider group) being disproportionately affected by individual provider(s) with small panels. According to this panel-weighted methodology:
(i) A provider's panel-weighted performance rate is determined as the provider's observed performance rate multiplied by the provider's member panel size
(ii) A panel-weighted mean for a group of providers is determined as the sum of panel-weighted performance rate for all providers in the group, divided by the total number of members attributed across all providers in the group
(iii) A provider's panel-weighted standard deviation is determined as: the square root of PWV2/SP, where PWV2 is determined as the squared difference between a provider's completion rates (the “raw” score, or the completion rate, prior to being transformed into a z score) and the panel weighted mean for that score, multiplied by the number of members in the provider's panel; and where SP is determined as the total number of members scored across all providers in the group.
(iv) The z-score for a health care provider of a group of providers is therefore determined, in one example, by subtracting a panel-weighted mean for the group from the observed performance rate of the health care provider, and then dividing by a panel-weighted standard deviation. Thus, the equation for panel-weighted z-score is: Provider z-score=((Provider's Observed Performance Rate)−(Panel-weighted mean))/panel-weighted standard deviation.

A provider's z-score (also herein referred to as “quality score” or “standard score”) for a particular domain is a blended, panel-weighted average of the applicable individual metric measures (z-scores) of the metrics for that domain. Thus, z-scores from a lower (e.g. metric) level comprise the basic metrics for the determination of z-scores at the next (e.g. domain) level. A ceiling in the z-scores can be applied at any level. Thus, z-scores at any level may be constrained to be no higher than a particular value, providing a “cap” z-score construction consistent at each of the three levels of z-score determination: the individual metric-level, the domain-level (across metrics for the domain), and the composite-level (across the domains). Because some metrics require that there be eligible members from the member panel in order to form a denominator (who is eligible among the panel for the measure) to score a provider on that metric, not every provider will have a score on every individual measure, or perhaps even necessarily on every domain. Thus, in some embodiments, the final composite quality index score is provided only for providers who meet a minimum threshold of completed individual measures and/or domains.

Determination of Expected Values and Percent Difference:

Expected values for measures such as potentially avoidable services, population health status, and continuity of care, can be influenced by a particular member's chronic illness burdens. Therefore, expected values are determined based on member clinical risk classification, gender, and age group, as examples. A case-mix classification pool refers to a group of members for which expected values for health-related measures are determined (e.g. calculated) based on a combination of those three characteristics. The case-mix classification pool reflects the disease morbidity for patients who are classified into that same risk pool. The experience of members within the same case mix pool is calculated for all relevant service metrics (i.e. as quality scores across the quality domains), and an average experience is determined using the expected experience for members of that case mix classification pool. This average experience is referred to more generally herein as simply the ‘Expected’. In this manner, the expected experience for members is calculated, in one example, as the average of a group that is ‘like the member’, which, in one embodiment, means that the group is of the same or similar age, sex, and disease category. By way of specific example, an expected potentially avoidable emergency room visit rate of a case-mix classification pool is determined by summing the expected potentially avoidable emergency room visits across all individual members of the risk pool, and then dividing that sum by the number of members in the risk pool. Thus, a provider's expected potentially avoidable emergency room rate is the blended expected average rates for the observed population of members who are attributed to that particular provider.

The “Percent Difference” for a provider refers to the difference between an observed reported value (determined from health care claims data, in one example) and the ‘Expected’ performance value. Thus, in one example, Percent Difference is determined as ((observed reported value—Expected)/Expected)×−100%. The difference is multiplied by −100% to create a measure where positive performance is represented by a positive percentage. In one example, this approach, where positive performance is better, is consistent across all quality scores from which the quality index score is determined.

Example Domains:

The following provides further details about each of seven health care quality domains identified above, and the overall methodology for computing the quality index score for a provider. The order in which the health care quality domains are presented below is arbitrary and not reflective of their respective importance in calculating the quality index score.

Domain 1—Member Experience:

Patient (member) experience reflects how the patient perceives his/her relationship with the practice and the care received there, and can have an impact on clinical outcomes. As a result, payers can look closely at patient experience as a value-based purchasing (VBP) metric. This marks the movement toward new and growing financial incentives to strengthen patient experiences with care. In order to account for this emerging focus, the member experience health care quality domain provides a measure to evaluate patient perception of care within the quality index. This particular health care quality domain, in one embodiment, does not rely on claims data. Additionally or alternatively, this health care quality domain may be omitted from the composite quality index score, depending on whether member experience is deemed an important consideration.

In one example, quality scores for this domain are derived from member answers to survey questions. The metric results within this domain can be converted to z-scores in the same way (such as described above) that z-scores are determined for other metrics. The z-scores can be combined into the composite quality index score with equivalent weight of other metrics. Advantageously, the approach provided herein to scoring these patient experience metrics and including them in the composite makes the patient experience metrics more useful than they would be it they were instead considered in isolation from other objective indicators of clinical processes and outcomes.

The member experience domain generally assesses member perception of his/her self-efficacy in healthcare matters and of his/her relationship with, and access to, the provider, such as a primary care provider, also referred to herein as primary care physician or PCP. In one example, the member experience domain uses four measures: patient confidence, continuity of care, office efficiency, and access to care. Quality scores for each of these can be determined from member answers to survey questions focused on their confidence in understanding and controlling their health care, their perceptions of the continuity of their care, office efficiency, and access to care. In one particular embodiment, such questions may be those described in, or derived from, the Consumer Assessment of Healthcare Providers and Systems (CAHPS) surveys provided by the U.S. Department of Health and Human Service's Agency for Healthcare Research and Quality (see, e.g., http://www.ncqa.org/Portals/O/Programs/Recognition/Companion_Guide/Standard %208.

A member experience rate is determined for each survey question using the equation: member experience rate=positive responses from the provider's member panel±total number of responses from the provider's member panel. From these member experience rates within the health care provider's panel, an average member experience z-score is determined for that provider, for instance by first finding z scores for each question, and then averaging those.

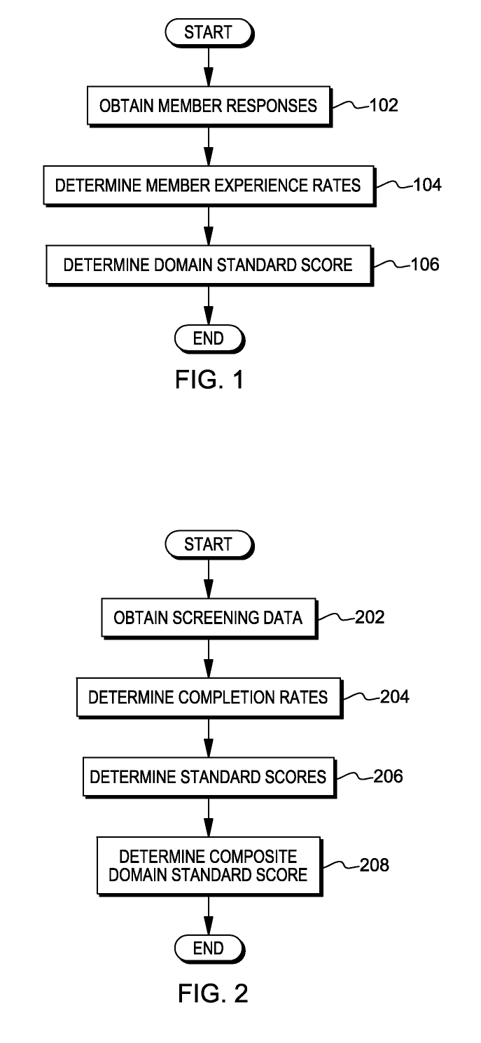

FIG. 1 therefore depicts one example of a process for determining a provider's member experience domain quality score, in accordance with one or more aspects of the present invention. Initially, a determination can be made as to which members are eligible among the panel(s) for the measure, and then performing the process with respect to those eligible members. The process begins by obtaining member feedback (e.g. responses to questions, in the form of data) (102). This includes feedback from not only the members of the health care provider (which is the subject of the health care provider quality evaluation), but also from members of other health care providers within the subject health care provider's group (so as to provide the data to determine the standard scores). From this obtained data, member experience rate(s) are determined (104). For instance, a member experience rate for each question asked is determined based on the responses to that respective question. Finally, a standard score for the member experience domain is determined (106) for the provider, for instance based on an average (optionally weighted) of the determined individual member experience rates for all providers in the provider group. The determined domain standard score is thus the health care provider's quality score for the member experience health care quality domain.

Domain 2—Primary and Secondary Prevention:

The primary and secondary prevention health care quality domain measures the provider's performance with screening services designed for early detection or prevention of disease. This domain employs a data set for measuring performance on important dimensions of care and service. In one example, the data set is drawn from the National Committee for Quality Assurance's (NCQA) Healthcare Effectiveness Data and Information Set (HEDIS), a tool for measuring performance on dimensions of care and service.

Screening data can include, as examples, screenings for breast cancer, cervical cancer, colorectal cancer, sexually transmitted diseases, such as Chlamydia, and well child exams.

Breast cancer (mammogram) screening can be represented as a fractional value in which the denominator is the number of female attributed members within a particular age range, for instance ages 40 through 69, who have not had a mastectomy, and in which the numerator is the total number of attributed members of the health care provider who have had a mammogram. The measure and eligibility criteria can be identified from the health care claims data using ICD and CPT codes for mammograms and exclusion criteria, in one example.

Colorectal cancer screening can be represented as a fractional value in which the denominator is the number of attributed members within in a certain age range, for instance age 50 and above, who have not had a colectomy and do not have colorectal cancer, and in which the numerator is the number of attributed members of the health care provider who have received a colonoscopy, sigmoidoscopy, or stool test. This measure can be identified from the health care claims data using ICD and CPT codes, in one example. Because the expected frequencies of colonoscopies, sigmoidoscopies, and stool test are different, weighting of the history of these tests can be adjusted. For instance, expected frequencies for colonoscopies, sigmoidoscopies, and stool tests may be every 10 years, 5 years and annually, respectively, and the weighting of these tests is, in one example, 1, 0.5, and 0.1 respectively, in summing the performance of a provider within the provider's member panel during a particular year. In embodiments where more than one year of claims data is used for determining these quality scores, then the weighting can be adjusted appropriately.

Well-child visits can be represented, in one example, as a percentage of attributed members who turned a particular age, such as 15 months old, during the performance year (the year for which the quality score is being determined) and who had a particular number of well-child visits with a PCP during their first 15 months (in this example) of life. The particular number of well-child visits with a PCP could be, for instance, 0, 1, 2, 3, 4, 5, 6 or more well-child visits. This measure can be identified from the health care claims data using ICD and CPT codes for well care services, in one example. Additionally or alternatively, well-child visits can be represented as a percentage of attributed members in a particular age range, for instance 3-6 years of age, during the performance year who had one or more well-child visits with the provider, determined from health care claims data using ICD and CPT codes for well care services, in one example.

Thus, in one particular embodiment, the primary and secondary prevention domain includes quality scores for:
(i) Percent of the provider's pediatric well-child visits, such as percent of attributed members aged 0 to 15 months, and/or percent of attributed members aged 3-6 years, who complete a recommended number of well-child visits with the primary care physician;
(ii) Percent of the provider's mammogram screening to the applicable patient population; and
(iii) Percent of the provider's colorectal cancer screening to the eligible patient population.

The metrics for all measures are percent completion, in this example. These metrics are prevention interventions in the general population with long-term value in the early detection and prevention of disease. Additionally or alternatively, quality scores for other metrics with similar value for scoring within this domain and can be incorporated into the measurement and weighting scheme for the domain.

FIG. 2 therefore depicts one example of a process for determining a provider's quality score for a primary/secondary prevention domain, in accordance with one or more aspects of the present invention. Initially, a determination can be made as to which members are eligible among the panel(s) for the measure, and then performing the process with respect to those eligible members. First, screening data, for instance data about well-child, mammographic, and colorectal screening, is obtained (202). This includes health care claims data and other data about not only the members of the health care provider (which is the subject of the health care provider quality evaluation), but also about members of other health care providers within the subject health care provider's group (so as to provide the data to determine the standard scores). Next, a completion rate (percent completion) for each screening metric is determined (204), and a standardized score for each of these screening metrics is determined from the determined completion rates (206). Based on the determined standard scores, a composite domain standard score for the primary/secondary prevention domain is determined (208). This determined composite domain standard score is thus the health care provider's quality score for the primary/secondary prevention health care quality domain.

Domain 3—Tertiary Prevention:

Primary and secondary prevention services discussed above are intended to promote general well-being and prevent long-term health consequences. A tertiary prevention health care quality domain can be further included in the composite health provider quality score, to provide an evaluation of the effectiveness of a provider in addressing “sick” care. This domain incorporates, in one example, two measures for the provider's performance on minimizing risk and sequela for attributed members experiencing episodes of illness. These measures are:
(i) percent difference between the Expected number of hospital admissions that are potentially preventable, and the actual (observed reported) number of potentially preventable hospital admissions for the provider's attributed member population; and
(ii) percent difference between the Expected number of hospital emergency room visits that are potentially preventable, and the actual (observed reported) number of potentially preventable hospital emergency room visits for the provider's attributed member population.

In both examples, the concept of preventable admissions and emergency room visits is based on the idea of ambulatory care sensitive conditions—conditions that are amenable to ready access to good quality primary care. An example list of ambulatory care sensitive conditions is maintained by the federal agency for Health Care Research and Quality, although numerous other lists exist. Diagnoses from these lists representing the principle reason for an admission or emergency room visit become the basis for the preventable admissions or emergency room visit metrics of the domain. For each of potentially preventable hospital admission rate and potentially preventable emergency room visit rate, a corresponding z-score for the provider can be determined. From these metric quality scores, a blended domain z-score (domain quality score) for the tertiary prevention domain is determined for the provider, and indicates standard deviation from the average among multiple providers, to determine a percent ranking of the provider among the multiple providers.

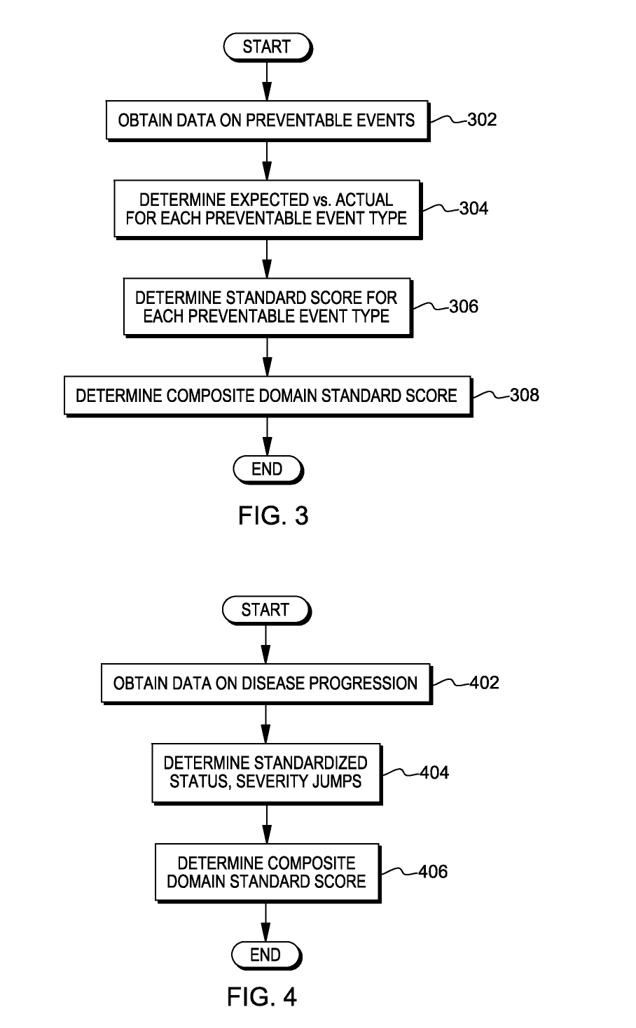

FIG. 3 therefore depicts one example of a process for determining a provider's quality score for a tertiary prevention health care quality domain, in accordance with one or more aspects of the present invention. Initially, a determination can be made as to which members are eligible among the panel(s) for the measure, and then performing the process with respect to those eligible members. First, data on potentially preventable events is obtained (302). This includes health care claims data and other data about not only the members of the health care provider (which is the subject of the health care provider quality evaluation), but also about members of other health care providers within the subject health care provider's group (so as to provide the data to determine the standard scores). In one example, two potentially preventable event types are included: potentially preventable hospital admissions and potentially preventable emergency room visits. Based on the obtained data, a percent difference between Expected and Actual is determined for each preventable event type (304), and based on these determined rates, a standard score for each potentially preventable event type is determined (306). Based on these determined standard scores, a composite domain standard score for the tertiary prevention health care quality domain is determined (308). This determined composite standard score is thus the health care provider's quality score for the tertiary prevention health care quality domain.

Domain 4—Population Health Status:

One measure for determining a provider's ability to deliver quality care is the provider's ability to manage the health status of its patient panel from one time period to another. This domain is directed to determining whether the particular provider's patients are doing better, health-wise, than would be expected on average. This measure can be risk adjusted and use the power of health status categories to summarize changes in health status over a time range.

The population health status health care quality domain uses a clinical risk classification system, such as the 3M® Clinical Risk Grouping Software, to conduct a risk-adjusted assessment of the percent difference between the expected rate of disease progression and the actual rate of the disease progression in the provider's patient panel.

In one particular embodiment, two metrics of disease progression are used for the health status change of the provider's attributed members with chronic conditions. The first metric describes the change in the number of chronic conditions. In one example, it is a count of a patient's discrete chronic diseases as identified by diagnosis codes (for instance, a patient progressing from having diabetes alone to having diabetes and congestive heart failure; or a patent progressing from having diabetes and congestive heart failure to having diabetes, congestive heart failure and chronic obstructive pulmonary disease, as examples). The second metric represents the progression in the severity within the chronic conditions (for example, a patient progressing from having simple insulin-controlled diabetes to having unstable diabetes rarely controlled by medication, as an example). Severity progression is identified using a combination of changes in diagnosis codes for that chronic condition and the incidence of increasingly severe interactions with the health care system, such as through emergency room visits, hospitalizations, etc. In order to determine these measures, data from two time periods (for instance, two performance years) is considered. The more recent time period (for example, a current performance year) is compared to a previous time period (for instance, a previous performance year).

The first metric can be represented as a fractional value in which the denominator is the number of attributed members with dominant chronic condition(s) in the previous performance period, and in which the numerator is the number of attributed members who acquire additional dominant chronic condition(s) in the current performance period.

The second metric can be represented as a fractional value in which the denominator is the number of attributed members with dominant chronic condition(s) in the previous performance period, and the numerator is the number of attributed members who move more than a predetermined range of severity level, as measured by the clinical risk classification system, in the current performance period.

The observed values of these two metrics are compared to the risk-adjusted Expected in the format of percent difference, as described above, which produces a performance z score of chronic care for the provider with respect to the performance of all other providers.

In this manner, risk from one time period to another (e.g. next) time period is evaluated and related back to the provider.

FIG. 4 therefore depicts one example of a process for determining a provider's quality score for a population health status health care quality domain, in accordance with one or more aspects of the present invention. Initially, a determination can be made as to which members are eligible among the panel(s) for the measure, and then performing the process with respect to those eligible members. First, data on disease progression for one or more diseases is obtained (402). This includes health care claims data and other data about not only the members of the health care provider (which is the subject of the health care provider quality evaluation), but also about members of other health care providers within the subject health care provider's group (so as to provide the data to determine the standard scores). From the obtained data, standardized status and severity jumps are determined (404). A composite domain standard score for the population health status domain is determined (406), which represents the health care provider's quality score for the population health status health care quality domain.

Domain 5—Continuity of Care:

This health care quality domain measures the concentration and continuity of physician visits. The continuity of care domain is representative of a number of positive outcomes, such as lower rates of hospitalization and readmissions, more efficient medical care, and higher patient satisfaction. The Agency for Health Care Research and Quality recognizes the importance of continuity of care (COC) measures by including such in the recommended atlas of coordination measures. Specifically, this domain includes:
(i) A fractional value representing the percentage of attributed members of a provider who did not have a physician visit, in which the denominator is the number of all attributed members of that provider, and the numerator is the number of attributed members of that provider who did not have a physician visit (in one example, this value is not risk-adjusted);
(ii) A fractional value representing the percentage of attributed members of the provider who had primary care physician visits, in which the denominator is the number of all attributed members of the provider and the numerator is the number of attributed members of the provider with a visit to a primary care physician (including, in one example, a physician's assistant and/or nurse practitioner who perform primary care function for patients) (in one example, this value is not risk-adjusted); and
(iii) A risk-adjusted continuity of care score determined for attributed members of the provider who have some minimum number (for instance at least four) of physician visits, including emergency department physician visits. The average continuity of care for all attributed members of the provider with at least the minimum number of visits is compared to expected average continuity of care for similar attributed members, which is, in one example, the expected average continuity of care for a group of people ‘like the member’.

The continuity of care is the degree to which a patient's care is concentrated among physicians. The index of continuity of care (COC score) depends on total number of visits, total number of physicians, and total number of visits with each physician.

An attributed member's continuity of care score can be determined as: ((Sum of the Squared Numbers of Visits to Each Distinct Provider)−Number of Visits for the Attributed Member)±(Number of Visits×(Number of Visits−1)). By way of specific example, an attributed member who saw one provider for four visits, another provider for two visits and two more providers for one visit each, would have a continuity of care score equal to: ((4²+2²+1²+1²)−8)±(8×(8−1))=0.250. In one embodiment, a visit by an attributed member to another provider in a primary care physician's group practice can optionally be counted as if the visit was to the primary care physician rather than to the separate provider. Likewise, visits by an attributed member to a different specialist physician under the same physician group can be counted as receiving care from the same physician if the physicians possess the same specialty code. Alternatively, the visit could be counted as if it was a visit to a different provider than the primary care physician or the specialist. The actual continuity of care score is compared to the expected continuity of care score for persons in the same case mix classification risk pool and the percent difference is determined.

In some embodiments, this aspect of the invention includes a constraint that at least a minimum number of visits be completed by the patient, and counts emergency room visits as provider visits, with each emergency room visit being a unique visit.

Higher continuity of care has been associated with lower rates of hospitalization and rehospitalization for pediatric, Medicaid, and veterans' populations, better adherence, more preventive care, and timely response to problems, and greater patient satisfaction and better management of behavioral health issues, as examples. Additionally, patients rank continuity as a key trait desired in their care.

In accordance with an aspect of the present invention, the continuity of care score may be extended to incorporate member health status (as indicated by, for instance, clinical risk group classification), average performance of a reference group, emergency department visits, as well as considerations about whether specialists and/or emergency departments were visited, the type of visit, and type of patient. A percent different in observed risk-adjusted continuity of care scores is compared to an expected continuity of care score for the primary care provider (equally weighted across risk groups, in one example.

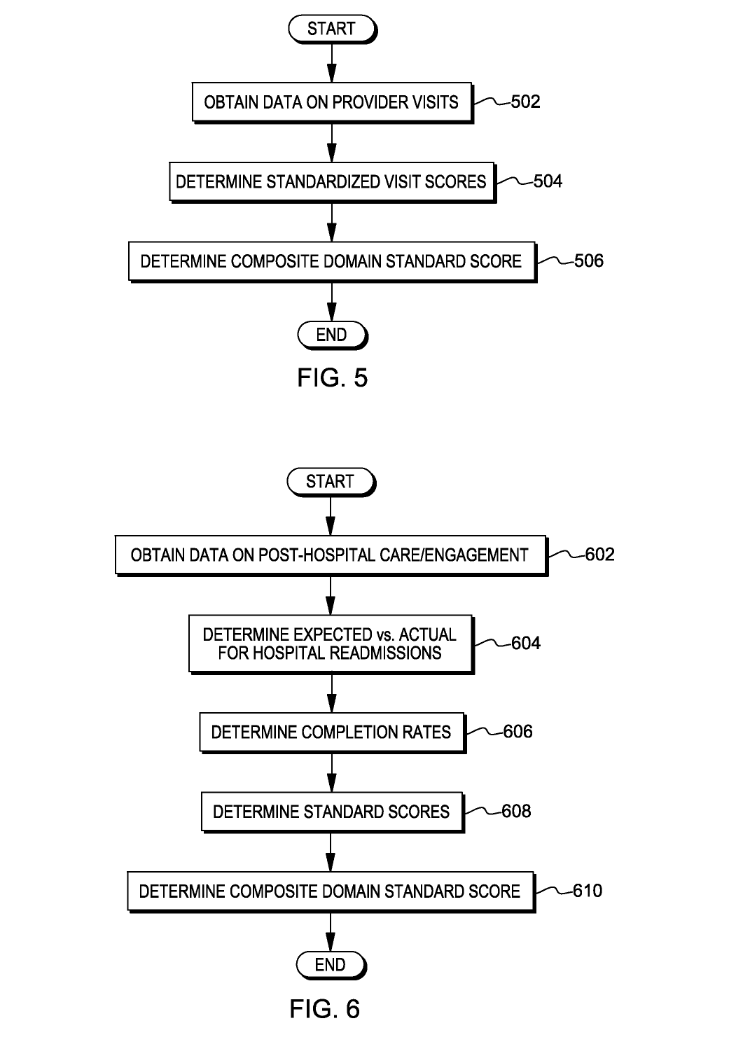

FIG. 5 therefore depicts one example of a process for determining a provider's quality score for the continuity of care health care quality domain, in accordance with one or more aspects of the present invention. Initially, a determination can be made as to which members are eligible among the panel(s) for the measure, and then performing the process with respect to those eligible members. First, data about provider is obtained (502). This includes health care claims data and other data about not only the members of the health care provider (which is the subject of the health care provider quality evaluation), but also about members of other health care providers within the subject health care provider's group (so as to provide the data to determine the standard scores). Next, standardized visit scores (such as for percentage of attributed members of a provider who did not have a physician visit, percentage of attributed members of the provider who had primary care physician visits, and risk-adjusted continuity of care score for attributed members) are determined (504), and a composite domain standard score for the continuity of care domain is determined (506). This determined composite domain standard score is thus the health care provider's quality score for the continuity of care health care quality domain.

Domain 6—Chronic Care and Follow-Up Services:

The quality index score can also incorporate a chronic care and follow-up services health care quality domain, to account for health care quality as it relates to members of the population who have chronic health conditions. The domain includes measures for the ability of the physician to provide access and manage patient conditions outside of the hospital, and for determining physician performance in providing post-hospital care and engagement. In one example, the measures included in the domain include:
(i) a risk-adjusted percent difference between the number of expected hospital readmissions of attributed members, and the provider's actual number of readmissions;
(ii) percent of the provider's member panel that visited a provider office within some time frame (for instance 30 days) post hospital discharge; and
(iii) percent of the provider's panel with chronic disease that have some minimum number (for instance three or more) of provider visits

The chronic care and follow-up services domain measures the physician's provision of post-hospital care and engagement with attributed members who have chronic conditions. The metrics for these measures are percent difference between expected and actual for readmissions (for measure (i) above) and percent completion (for measures (ii) and (iii) above).

For measure (i) above, the domain examines a percent difference between observed and expected readmission rates. Measure (ii) above examines a percent completion rate of visits to any doctor (or any doctor within some defined set of doctors) for members with chronic conditions, and measure (iii) above examines a percent completion rate of a provider's office visit within some time frame post-discharge, such as 30 days after discharge from the hospital.

In one example, readmissions are defined as any return to a hospital within a particular time period after a discharge. The time period is, in one example, 30 days. Readmissions may also be defined as a return to the hospital for a non-traumatic or non-planned reason. The readmission rate is equal to the count of readmission discharges divided by all admissions. This actual rate is compared to the Expected rate in order to obtain a percent difference between the actual and the expected.

For measure (ii) above, the percent of the provider's panel that visited a provider office within some time frame post-hospital discharge can be represented as a fractional value in which the denominator is the number of hospital discharges within the time frame and the numerator is the count of discharges followed by a physician visit within the time frame.

For measure (iii) above, the percent of the provider's panel with chronic disease that have some minimum number of provider visits can be represented as a fractional value in which the denominator is the count of attributed members who have dominant chronic conditions and the numerator is the count of these attributed members who have received the minimum number of physician visits annually.

Z-scores can be determined for all three of the above metrics and used in determining a blended domain quality score for chronic care and follow-up services.

FIG. 6 therefore depicts one example of a process for determining a provider's quality score for a chromic care and follow-up services health care quality domain, in accordance with one or more aspects of the present invention. Initially, a determination can be made as to which members are eligible among the panel(s) for the measure, and then performing the process with respect to those eligible members. First, data about post-hospital care and engagement is obtained (602) which, in one example, includes data about readmission rates, post-discharge visits, and chronic-disease-based provider visits, as described above. This includes health care claims data and other data about not only the members of the health care provider (which is the subject of the health care provider quality evaluation), but also about members of other health care providers within the subject health care provider's group (so as to provide the data to determine the standard scores). Next, based on the obtained data, a percent difference between Expected and Actual is determined for hospital readmissions (604), and post-hospital discharge and chronic-disease-based minimum visit completion rate(s) are determined (606). Standardized scores are determined for these metrics (608) and finally a composite domain standard score for the chronic care and follow-up services health care quality domain is determined (610). This determined composite domain standard score is thus the health care provider's quality score for the chronic care and follow-up services health care quality domain.

Domain 7—Efficiency Measure:

Health care efficiency is the efficiency of resource usage in producing a given set of health outcomes. There can be a wide variation in the use of ancillary and pharmaceutical resources to achieve the same outcomes, and significant savings to consumers and payers may result from moving all care to more efficient levels. In addition, increased expenses in terms of time and out-of-pocket costs arising from unnecessary resource use can lead to lower patient adherence and therefore poorer patient outcomes. Furthermore, unnecessary services can carry the risk of iatrogenic harm as well. Many measures of efficiency rely on dollar differences in all costs of care among similar patients. Aspects of the present invention take a categorical approach of examining the use of specific services associated with overuse. The efficiency health care quality domain examines the overuse of outpatient ancillary services for a provider's member panel, as well as the provider's rate of prescribing generic medications. In one example, the costs of outpatient ancillary services are analyzed with high degrees of geographic variation and little clinical evidence supporting frequent use, such as Magnetic Resonance Imaging for low back pain, or Fiberoptic Endoscopy use for tonsillitis, adenoiditis, and pharyngitis without surgery or ordered by a primary care physician or specialist that may not provide useful information for diagnosis and treatment. Thus, the efficiency domain examines, in one example:
(i) Risk-adjusted percent difference in costs between a provider's actual costs of potentially overused services and the provider's Expected costs of potentially overused services; and
(ii) Percent difference between a provider's actual rate of prescribing generic drugs (“generic prescribing rate”) and the Expected rate.

Example Evaluation of Health Provider Quality:

The following provides an example in which a composite quality index score is determined for a health care provider (in this case a primary care practitioner), in accordance with aspects of the present invention. In this example, the first six domains described above are used to determine the composite quality score for the primary care practitioner.

Dr. Smith is a primary care practitioner (PCP) for a Health Care Plan (HCP). Her member panel characteristics are displayed in Table 1, below, along with composite health provider quality scores (QIS) for each of years 2008-2010. These scores are determined as described below, and thus the composite quality index scores in Table 1 present a summary outcome of the evaluation of Dr. Smith's health provider quality, in accordance with aspects of the present invention. As seen from Table 1, although the QIS may be relatively stable for Dr. Smith year over year, this is not always the case, and the changes can be instructive.

TABLE 1
Dr. Smith's Panel

| | | | | | PMPM | | | |
|---|---|---|---|---|---|---|---|---|
| | | Average | | | PCTDIFF | | | |
| | | Member | Average Risk | | from | Hosp | QIS Z | QIS % |
| Year | Members | Age | Weight | PMPM | expected | D/C's | Score | Rank |
| 2010 | 405 | 33 | 1.44 | $367 | −9.80% | 28 | 0.68 | 77% |
| 2009 | 367 | 32 | 1.23 | $293 | −17% | 19 | 0.29 | 61% |
| 2008 | 393 | 31 | 1 | $276 | −0.56% | 20 | 0.28 | 61% |

With 393, 367, and 405 members in years 2008, 2009, and 2010 respectively, most of Dr. Smith's members were enrolled continuously during the period 2007 through 2010, although she did acquire some new members in 2010. Information from the prior year(s) about those added members may not be available and, consequently, would not factor into the scoring of one or more health care quality domains in 2010, such as the health status domain, but would factor into Dr. Smith's scoring on the other domains for which they were eligible.

Overall, Dr. Smith cares for a relatively young mixed population of children and adults (as indicated by average member age), with higher risk scores (i.e., Average Risk Weight) than average in 2009 and 2010. Her cost per member per month (PMPM) is less than expected (PMPM PCT DIFF from expected) in all three years, as indicated by the negative values for this measure. Her QIS performance improved in raw scores (QIS z-score) and ranking in the last two years.

Domain 1—Member Experience:

In this example, quality scores for the member experience domain are determined based on patient surveys using average scores for the providers of the HCP.

The example below illustrates how efficiency scores work against current national median scores. Later in this document, it is illustrated how those scores would factor into the QIS for Dr. Smith.

Each quality score for member experience corresponds to a particular question, and is determined as the percent of respondents who reported the positive response, divided by the total number of respondents. In this example, the following questions are used: (i) Question 1—Access: ‘How easy is it for you to get medical care when you need it?’; (ii) Question 2—Efficiency: ‘When you visit your doctor's office, how often is it well organized, efficient, and does not waste your time?’; (iii) Question 3—Confidence: ‘Are you confident in managing your health problems?’; (iv) Question 4—Continuity: ‘Do you have one person you think of as your personal doctor or nurse?’.

TABLE 2
Example of Member Experience scores for Dr. Smith

| | | | Efficiency | | Confidence | | | | | |
|---|---|---|---|---|---|---|---|---|---|---|
| | Access (1) | | (2) | | (3) | | Continuity (4) | | | PE % |
| Year | Actual | Target | Actual | Target | Actual | Target | Actual | Target | PE Z | Rank |
| 2008 | 0.375 | 0.5 | .60 | 0.8 | 0.40 | 0.5 | 0.75 | 0.8 | 0.15 | 50% |
| 2009 | 0.375 | 0.5 | .60 | 0.8 | 0.40 | 0.5 | 0.75 | 0.8 | 0.15 | 49% |
| 2010 | 0.375 | 0.5 | .60 | 0.8 | 0.40 | 0.5 | 0.75 | 0.8 | 0.15 | 50% |

Table 2 simulates how that data would fold into the QIS. In the example, the numbers are constant form year-to-year merely for illustration purposes; in practice, this consistency from year-to-year would be extremely unlikely. Answers to patient survey questions are collated for Dr. Smith's members, and the average response from her group practice would be used to supplement those missing responses. Group practice, in this context, refers to the primary care physicians in Dr. Smith's practice group, though the definition of ‘group practice’ is fungible and ultimately defined by the provider or the payer. The average score across the questions (four in this example) would be converted to a z-score based on the average across all PCPs in the HCP. The four questions may be binary questions (e.g. soliciting a Yes or No answers), so that the average response across the four questions can be defined as “percent positive.” Dr. Smith's responses might be 53% positive, for instance, and translated into a z-score of 0.15 (in this example) which, as explained above, would depend on the distribution of all responses obtained in the peer reference group data.

Domain—Primary/Secondary Prevention:

Primary/secondary prevention is the second domain and includes pediatric well care (Child Well Visits; Infant Well Visits) and cancer screens (Breast CA Screen; ColoRectal CA Screen), in this example.

TABLE 3
Dr. Smith's Primary/Secondary Prevention(PP) Performance

| | % w/ | | % | | % | | | | | | |
|---|---|---|---|---|---|---|---|---|---|---|---|
| | Breast | Breast | infant | | Child | | % Colo- | CR | | | |
| | CA | CA | Well | Infant | Well | Child | Rectal CA | CA | | | PP % |
| Year | Screen | Screen Z | Visit | Well Z | Visit | Well Z | Screen | Screen Z | PP Avg | PP Z | Rank |
| 2010 | 54% | 0.14 | 43% | 0.54 | 75% | 0.54 | 6% | −0.74 | 0.12 | 0.14 | 57% |
| 2009 | 51% | −0.19 | 0% | −0.75 | 52% | −0.22 | 16% | 0.03 | −0.28 | −0.42 | 31% |
| 2008 | 51% | −0.17 | 14% | −0.23 | 81% | 0.79 | 11% | −0.44 | −0.01 | −0.06 | 48% |

Referring to Table 3, in 2008, 51% of Dr. Smith's eligible panel members received breast cancer screening. This percentage is standardized as a z-score of −0.17 which represents where her performance is in relation to the average performance and spread of scores among all other PCPs in Dr. Smith's Health Care Plan reference pool for breast cancer screening in 2008. The z-score of −0.17 indicates her performance of screening for 51% of eligible women is below average for the reference pool. In 2009, the percentage of eligible women screened by Dr. Smith remained the same (meaning there was no change in Dr. Smith's screening rate). But, because the performance in the peer reference group (all PCPs in the HCP) was a little better overall in 2009, Dr. Smith's z-score dropped to −0.19. In 2010, her screening rate rose to 54% and this resulted in a positive z-score of 0.14, representing an above-average screening rate in relation to the overall reference group.

Well-child visits and colorectal cancer screening can be understood in the same way. For instance, with respect to colorectal screening, Dr. Smith's completion rate for 2010 was 6% of eligible adults receiving screening, which is below average as indicated by the negative z score of −0.74. Dr. Smith's completion rates for infant and young child well care were 43% and 75% respectively in 2010, and the z-scores were coincidentally the same, at 0.54, indicating that her performance against the reference group was better than average. Her performance with infant well care was below average (−0.75 and −0.23) in prior years.

The primary/secondary prevention domain quality score is determined, in this example, by taking the average scores for all measures in the domain, subtracting the mean for all PCPs in the Health Care Plan, and dividing by the standard deviation of scores for all PCPs in the Health Care Plan. Thus, in 2010, Dr. Smith's primary prevention score is 0.14, indicating above average, and better than previous years', performance. Given her scores, her primary prevention percentile ranking among all PCPs in the Health Care Plan is determined to be 57% in 2010, 31% in 2009, and 48% in 2008.

Domain—Tertiary Prevention:

Tertiary prevention is the third domain and includes the rate of potential preventable emergency room visits (PPVs) and ambulatory sensitive acute admissions (PPAs.)

TABLE 4
Dr. Smith's Tertiary Prevention (TP) Performance

| | PPA % | | PPV % | | | SP % |
|---|---|---|---|---|---|---|
| Year | Diff | PPA Z | diff | PPV Z | TP Z | Rank |
| 2010 | 21% | 0.10 | 44% | 0.78 | 0.61 | 74% |
| 2009 | −03% | −0.03 | 53% | 1.00 | 0.67 | 78% |
| 2008 | −94% | −0.58 | 34% | 0.57 | −0.01 | 41% |

The expected rates for all panel members are determined for each measure using disease status, age, and gender, and compared to the actual rates for the panel to create the percentage difference in performance (PPA % Diff; PPV % Diff). Each of these is converted to a respective z-score, and the domain score is determined from these z-scores. Referring to Table 4, in 2008, Dr. Smith's performance was 94% below what was expected for ambulatory sensitive admissions and 34% better than expected on ambulatory sensitive emergency room visits. Her blended domain score for 2008, −0.01 (the sum of PPA z-score and PPV z-score for), indicates just below-average performance, which was, in this example, equal to or better than 41% of all PCPs in the Health Care Plan (in all years for this domain, the median score was higher than the mean). Dr. Smith's performance on both inpatient and emergency room ambulatory sensitive conditions improved in 2009 and 2010 and those results are reflected in her score and rankings.

Domain—Chronic Care and Follow-Up Screening:

This is the fourth domain and includes follow-up after hospital discharge (D/C F′up) within 30 days visits with members with dominant chronic conditions at least 3 times a year, and potentially preventable readmission rates, in this example.

TABLE 5
Dr. Smith's Follow-up Performance

| | % Chronic | | | | % Diff | | | |
|---|---|---|---|---|---|---|---|---|
| | Members w | | % Post | | in PPR | | Follow | Follow % |
| Year | 3vsts | CC3VST Z | D/C F′up | DC30 Z | rate | PPR Z | Up Z | Rank |
| 2010 | 88% | 0.45 | 61% | 0.21 | 100% | 0.87 | 0.64 | 76% |
| 2009 | 87% | 0.26 | 42% | −0.54 | −42% | −0.32 | −0.21 | 34% |
| 2008 | 82% | −0.15 | 45% | −0.41 | 100% | 0.85 | 0.14 | 52% |

Dr. Smith's performance improved on visits for chronic care members and post discharge follow-up. Her performance on preventable readmissions declined in 2009 and is reflected in her scores and ranking.

Domain—Continuity of Care:

This is the fifth domain and includes a risk adjusted continuity of care score, the percentage of members who saw the PCP during the year, and the percentage who saw any physician.

TABLE 6
Dr. Smith's Continuity Performance

| | % Had | | % Visited | ANY | | | | |
|---|---|---|---|---|---|---|---|---|
| | PCP | PCP | Any | PHYS | COC % | | | Continuity |
| Year | Visit | VST Z | Physician | VST Z | Diff | COC Z | Continuity Z | % Rank |
| 2010 | 95% | 0.49 | 97% | 0.36 | −4.90% | −0.14 | 0.33 | 61% |
| 2009 | 93% | 0.07 | 95% | −0.25 | 3.10% | 0.21 | 0.02 | 45% |
| 2008 | 95% | 0.39 | 97% | 0.4 | −4.30% | −0.14 | 0.3 | 60% |

Dr. Smith had better than average continuity in 2010 than in 2009 and 2008 (0.33 vs. 0.02 and 0.3). Also note that Dr. Smith's ranking in 2008 was impacted by relatively small changes in the percentage of her panel that were non-users and the number who saw her or another PCP. Those measures have some redundancy, and have little variation in the reference pool. They act as threshold measures in the QIS for which there is very little forgiveness.

Domain—Population Health Status:

Health Status is the sixth domain and includes risk adjusted measures of change in chronic conditions and severity for the panel members. This measure is determined when the PCP has at least 10 (in this example) eligible panel members.

TABLE 7
Dr. Smith's Health Status Performance

| | Non | | Non | | | |
|---|---|---|---|---|---|---|
| | Status | | Severity | | | Health |
| | Jump | STATUS | Jump % | SEVERITY | Health | Status % |
| Year | % Diff | JUMP Z | Diff | JUMP Z | Status Z | Rank |
| 2010 | −3.00% | −0.39 | 2.30% | 0.65 | 0.17 | 56% |
| 2009 | 5.10% | 0.7 | 1.50% | 0.46 | 0.76 | 81% |
| 2008 | −4.80% | −0.73 | 4.50% | 1.32 | 0.4 | 68% |

Percent differences in expected versus observed changes in health status and severity are relatively narrow in the reference group. Therefore, what may appear to be a modest percent difference can signal a change that is out of the ordinary, and these measures should be viewed with that in mind. Dr. Smith's panel is doing better than average on severity changes (i.e., experiencing less changes in severity than expected), while changes in dominant chronic conditions (i.e., status changes, denoted by Health Status Z) have been inconsistent. Note that these measures may be “lagging indicators” representing the impact of prior year care.

Determining the Composite Score:

The composite QIS is, in this example, a non-weighted average of the domain quality scores across the domains, converted into a z-score. The composite QIS percentile score is the percentile ranking of this composite score.

| | | | | Chronic | | Population | | |
|---|---|---|---|---|---|---|---|---|
| | Member | P/S | Tertiary | Care & | Continuity | Health | | QIS |
| Year | Experience | Prevention | Prevention | Follow up | of Care | Status | QIS Z | Percentile |
| 2010 | .15 | 0.14 | 0.61 | 0.64 | 0.33 | 0.17 | 0.68 | 77% |
| 2009 | .15 | −0.42 | 0.67 | −0.21 | 0.02 | 0.76 | 0.29 | 61% |
| 2008 | .15 | −0.06 | −0.01 | 0.14 | 0.30 | 0.40 | 0.28 | 61% |

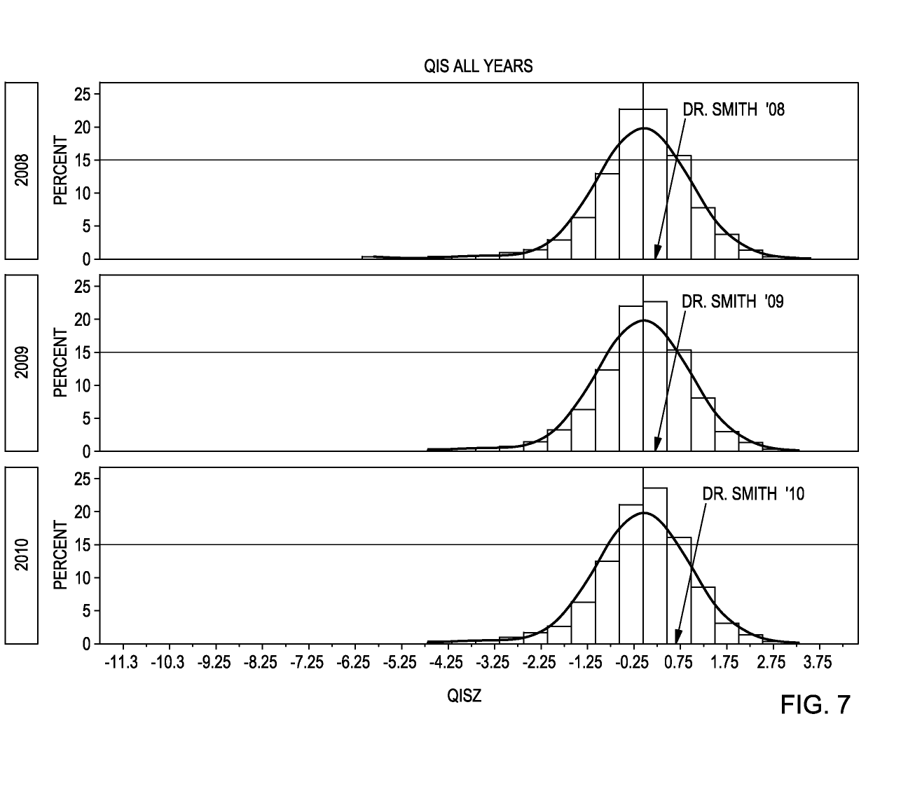

In one example, the composite score (QIS Z) is not simply the average of the provider's domain z scores, but instead is determined by the standard z score determination, for instance: obtaining the average for a provider for the provider's domain z scores, then comparing that against the average domain z scores for all providers, and determining the average deviation of all providers, then determining the particular provider's deviation from the overall average, and dividing by the standard deviation. Dr. Smith's composite score (QIS Z) is better than average in 2010, and is a significant improvement over the 2009 score. Primary prevention and members experience are the most obvious domains in which improvements would enhance her standing, since those are the domains with the lowest z-scores. Her performance in relation to all other PCP's in the HCP is displayed in FIG. 7, which depicts example plots indicating Dr. Smith's health provider quality as compared to health care providers of Dr. Smith's health care provider group.

There are three plots in FIG. 7—one for each of years 2008, 2009, and 2010. Each plot is a bar graph indicating the concentration of providers (of the provider group) with a standard score in a given range. The highest concentration is, as expected, at z-score=0. It is seen that in 2008 and 2009, Dr. Smith's position (i.e. quality) relative to all health care providers in the group was above-average, at 0.28 and 0.29 (standard score), respectively. Dr. Smith's quality improved (with respect to the average quality) in year 2010, with her 0.68 standard-score.

While the plots of FIG. 7 depict overall (composite) quality, similar plots could be produced for any constituent quality score of that composite. For instance, plot(s) for each domain can be produced, where quality scores (z-scores) for only a single domain are used to generate the plots. In this manner, comparisions of varying granularity may be provided.

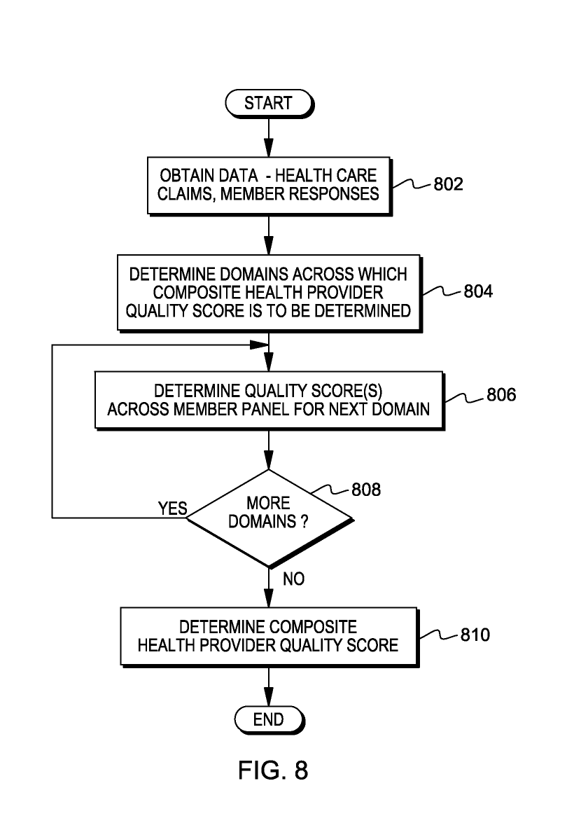

Described above, in accordance with aspects of the present invention, evaluation of health care provider quality is provided. An example of such a process is described and depicted with reference to FIG. 8. First, health care claims and member response data is obtained (802). The domain quality scores are determined based, at least in part on this obtained data, as described above. Additional data about members of the provider's member panel and/or members of other health care providers in the subject provider's health care group may also be obtained.

Next, a determination is made as to the domains across which health care provider quality is to be evaluated (804). Described above are seven example domains, though others are possible. The evaluation with respect to Dr. Smith involved six of the described domains. The particular domains across which the evaluation is to be made (i.e. the domains for which quality scores are determined and incorporated into the composite quality index score) may be determined based on, for instance, goals of a particular client (e.g. a stakeholder) commissioning the quality index scoring of the health care provider.

Once the domains are determined, quality score(s) for the provider are determined across that provider's member panel for a next domain (806). For instance, a first domain is selected, and quality score(s) for that domain are determined for that provider, which will factor into a composite health provider quality score. The example processes of FIGS. 1-6 represent examples of determining quality score(s) for each of the respective six domains.

It is then determined whether there are more domains (of the domain determined at (804) for which quality score(s) are to be determined (808). If so, the process returns to (806) to determine quality score(s) for a next domain. Otherwise, the quality score(s) for each of the domains have been determined. The process proceeds to (810) where a composite health provider quality score is determined for the healthcare provider. In this manner, a composite health care provider quality score is a composite of the determined quality scores across the member panel of that provider and across the multiple health care quality domains selected for incorporation into the composite health care provider quality score. In one example, the composite is an average (perhaps weighted according to a selected weighting scheme) of the quality scores determined for each of the selected multiple health care quality domains.

Thus, according to one or more aspects disclosed herein, a health care provider quality score is determined, at least in part, using one or more domain quality scores that are based on patient feedback (such as scores of the member experience domain) and/or health care claims data that is readily available. According to one or more aspects disclosed herein, risk-adjustment based on patient age/sex is applied to some domain quality scores. Furthermore, according to one or more aspects disclosed herein, none of the domains are disease-specific, that is, no measure is specifically about any specific disease in particular (diabetes, asthma, heart failure, etc).

This population-based composite quality index score offers a top line view of quality, represents an overview of the quality of care rendered by a health care provider. Current health care claims data is utilized to identify key measures that can be used to provide a quality perspective of the value for dollars spent, enabling stakeholders to drill down behind the composite quality index score and find specific opportunities for improvement. It is one resource that can be used by the involved parties to strengthen health care value and establish new and effective approaches to health care delivery and payment systems.

Those having ordinary skill in the art will recognize that aspects of the present invention may be embodied in one or more systems, one or more methods and/or one or more computer program products. In some embodiments, aspects of the present invention may be embodied entirely in hardware, entirely in software (for instance in firmware, resident software, micro-code, etc.), or in a combination of software and hardware aspects that may all generally be referred to herein as a “system” and include circuit(s) and/or module(s).

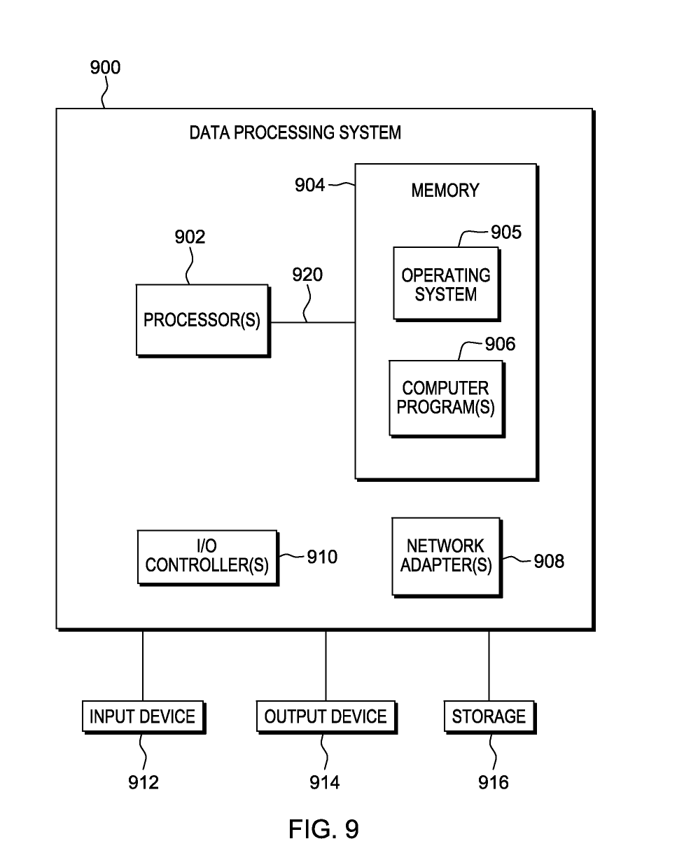

FIG. 9 depicts one example of a data processing system to incorporate and use one or more aspects of the present invention. Data processing system 900 is suitable for storing and/or executing program code, such as program code for performing the processes described above, and includes at least one processor 902 coupled directly or indirectly to memory 904 through, a bus 920. In operation, processor(s) 902 obtain from memory 904 one or more instructions for execution by the processors. Memory 904 may include local memory employed during actual execution of the program code, bulk storage, and cache memories which provide temporary storage of at least some program code in order to reduce the number of times code must be retrieved from bulk storage during program code execution. A non-limiting list of examples of memory 904 includes a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Memory 904 includes an operating system 905 and one or more computer programs 906, such as one or more programs for evaluating health provider quality in accordance with aspects of the present invention.

Input/Output (I/O) devices 912, 914 (including but not limited to keyboards, displays, pointing devices, etc.) may be coupled to the system either directly or through I/O controllers 910.

Network adapters 908 may also be coupled to the system to enable the data processing system to become coupled to other data processing systems through intervening private or public networks. Modems, cable modem and Ethernet cards are just a few of the currently available types of network adapters 908. In one example, network adapters 908 facilitate obtaining health care claims data for members of health care provider(s), as well as other data, from remote sources to facilitate aspects of the present invention.

Data processing system 900 may be coupled to storage 916 (e.g., a non-volatile storage area, such as magnetic disk drives, optical disk drives, a tape drive, etc.), having one or more databases. Storage 916 may include an internal storage device or an attached or network accessible storage. Computer programs in storage 916 may be loaded into memory 904 and executed by a processor 902 in a manner known in the art.

The data processing system 900 may include fewer components than illustrated, additional components not illustrated herein, or some combination of the components illustrated and additional components. Data processing system 900 may include any computing device known in the art, such as a mainframe, server, personal computer, workstation, laptop, handheld computer, telephony device, network appliance, virtualization device, storage controller, etc.

In addition, processes described above may be performed by multiple data processing systems 900, working as part of a clustered computing environment.

In some embodiments, aspects of the present invention may take the form of a computer program product embodied in one or more computer readable medium(s). The one or more computer readable medium(s) may have embodied thereon computer readable program code. Various computer readable medium(s) or combinations thereof may be utilized. For instance, the computer readable medium(s) may comprise a computer readable storage medium, examples of which include (but are not limited to) one or more electronic, magnetic, optical, or semiconductor systems, apparatuses, or devices, or any suitable combination of the foregoing. Example computer readable storage medium(s) include, for instance: an electrical connection having one or more wires, a portable computer diskette, a hard disk or mass-storage device, a random access memory (RAM), read-only memory (ROM), and/or erasable-programmable read-only memory such as EPROM or Flash memory, an optical fiber, a portable compact disc read-only memory (CD-ROM), an optical storage device, a magnetic storage device (including a tape device), or any suitable combination of the above. A computer readable storage medium is defined to comprise a tangible medium that can contain or store program code for use by or in connection with an instruction execution system, apparatus, or device, such as a processor. The program code stored in/on the computer readable medium therefore produces an article of manufacture (such as a “computer program product”) including program code.

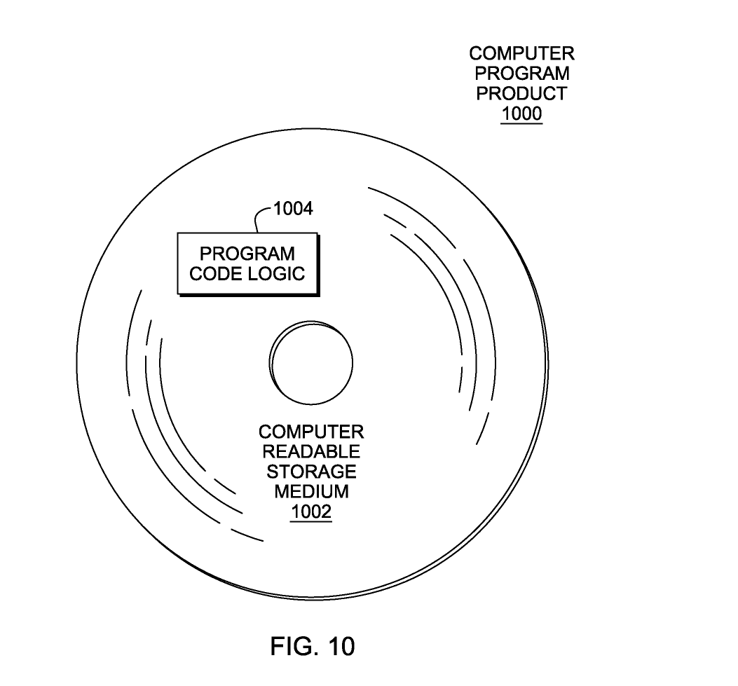

Referring now to FIG. 10, in one example, a computer program product 1000 includes, for instance, one or more computer readable media 1002 to store computer readable program code means or logic 1004 thereon to provide and facilitate one or more aspects of the present invention.

Program code contained or stored in/on a computer readable medium can be obtained and executed by a data processing system (computer, computer system, etc. including a component thereof) and/or other devices to cause the data processing system, component thereof, and/or other device to behave/function in a particular manner. The program code can be transmitted using any appropriate medium, including (but not limited to) wireless, wireline, optical fiber, and/or radio-frequency. Program code for carrying out operations to perform, achieve, or facilitate aspects of the present invention may be written in one or more programming languages. In some embodiments, the programming language(s) include object-oriented and/or procedural programming languages such as C, C++, C#, Java, etc. Program code may execute entirely on the user's computer, entirely remote from the user's computer, or a combination of partly on the user's computer and partly on a remote computer. In some embodiments, a user's computer and a remote computer are in communication via a network such as a local area network (LAN) or a wide area network (WAN), and/or via an external computer (for example, through the Internet using an Internet Service Provider).

In one example, program code includes one or more program instructions obtained for execution by one or more processors. Computer program instructions may be provided to one or more processors of, e.g., one or more data processing system, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

The flowcharts and block diagrams depicted and described with reference to the Figures illustrate the architecture, functionality, and operation of possible embodiments of systems, methods and/or computer program products according to aspects of the present invention. These flowchart illustrations and/or block diagrams could, therefore, be of methods, apparatuses (systems), and/or computer program products according to aspects of the present invention.

In some embodiments, as noted above, each block in a flowchart or block diagram may represent a module, segment, or portion of code, which comprises one or more executable instructions for implementing the specified behaviors and/or logical functions of the block. Those having ordinary skill in the art will appreciate that behaviors/functions specified or performed by a block may occur in a different order than depicted and/or described, or may occur simultaneous to, or partially/wholly concurrent with, one or more other blocks. Two blocks shown in succession may, in fact, be executed substantially concurrently, or the blocks may sometimes be executed in the reverse order. Additionally, each block of the block diagrams and/or flowchart illustrations, and combinations of blocks in the block diagrams and/or flowchart illustrations, can be implemented wholly by special-purpose hardware-based systems, or in combination with computer instructions, that perform the behaviors/functions specified by a block or entire block diagram or flowchart.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed. Additionally, the terms “determine” or “determining” as used herein can include, e.g. in situations where a processor performs the determining, performing one or more calculations or mathematical operations to obtain a result.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiment with various modifications as are suited to the particular use contemplated.

What is claimed is:

1. A method for evaluating health care provider quality, the method comprising:
obtaining data including health care claims data corresponding to health care claims by a member panel of a health care provider, the member panel comprising multiple patients to which the health care provider provides health care services;
determining, based at least partially on the obtained health care claims data, quality scores for the health care provider across the member panel and across multiple health care quality domains, wherein a health care quality domain of the multiple health care quality domains comprises a heath status domain, wherein a determined quality score of the health status domain comprises a measure of disease progression in members of the member panel of the health care provider; and
determining, by a processor, a composite health provider quality score of the health provider, the composite health provider quality score being a composite of the determined quality scores for the health care provider across the member panel and across the multiple health care quality domains.

2. The method of claim 1, wherein the measure of disease progression comprises a risk-adjusted assessment of the percent difference between an expected rate of disease progression and an actual rate of the disease progression in the members of the member panel of the health care provider.

3. The method of claim 1, wherein the multiple health care quality domains further comprise at least one of the following:
a member experience domain, from which a patient feedback quality score regarding quality of care by the health care provider is obtained;
at least one care prevention domain indicative of at least one of primary, secondary, or tertiary care prevention;
a continuity of care domain indicative of an extent to which an ongoing health care relationship is maintained between the health care provider and the member panel; or
a chronic-care and follow-up services domain indicative of an ability of the health care provider to provide chronic-care and follow-up services to the member panel.

4. The method of claim 3, wherein determining the quality scores comprises risk-adjusting quality scores of multiple domains of the member experience domain, at least one care prevention domain, continuity of care domain, or chronic care and follow-up services domain, wherein the risk-adjustment is performed against a peer reference base, and wherein the quality scores from which the composite health provider quality score is determined includes the risk-adjusted quality scores.

5. The method of claim 4, wherein the risk-adjustment is based, at least in part, on disease category, member age, and member sex of members of the member panel.

6. The method of claim 4, wherein the quality scores across the multiple health care quality domains are determined based at least partially on non-disease-specific health measures of the obtained health care claims data.

7. The method of claim 3, wherein the multiple health care quality domains comprise the continuity of care domain, and wherein determining the quality scores comprises risk-adjusting at least one quality score of the continuity of care domain based, at least in part, on member age, member sex, and member disease status of the member panel, wherein the risk-adjustment is performed against a peer reference base.

8. The method of claim 3, wherein the multiple health care quality domains comprise the continuity of care domain, and wherein a quality score of the continuity of care domain is based, at least in part, on emergency room visits of the member panel.

9. The method of claim 3, wherein the multiple health care quality domains comprise the continuity of care domain, wherein the health care provider comprises one or more primary care practitioners, and wherein a quality score of the continuity of care domain indicates continuity of care by the one or more primary care practitioners for the member panel.

10. The method of claim 1, wherein the multiple health care quality domains comprise the following health care quality domains:
a member experience domain, from which a patient feedback quality score regarding quality of care by the health care provider is obtained
at least one care prevention domain indicative of at least one of primary, secondary, or tertiary care prevention;
a continuity of care domain indicative of an extent to which an ongoing health care relationship is maintained between the health care provider and the member panel; and
a chronic-care and follow-up services domain indicative of an ability of the health care provider to provide chronic-care and follow-up services to the member panel.

11. A computer system for evaluating health care provider quality, the computer system comprising:
a memory; and
a processor in communication with the memory, wherein the computer system is configured to perform:
obtaining data including health care claims data corresponding to health care claims by a member panel of a health care provider, the member panel comprising multiple patients to which the health care provider provides health care services;
determining, based at least partially on the obtained health care claims data, quality scores for the health care provider across the member panel and across multiple health care quality domains, wherein a health care quality domain of the multiple health care quality domains comprises a heath status domain, wherein a determined quality score of the health status domain comprises a measure of disease progression in members of the member panel of the health care provider; and
determining a composite health provider quality score of the health provider, the composite health provider quality score being a composite of the determined quality scores for the health care provider across the member panel and across the multiple health care quality domains.

12. The computer system of claim 11, wherein the measure of disease progression comprises a risk-adjusted assessment of the percent difference between an expected rate of disease progression and an actual rate of the disease progression in the members of the member panel of the health care provider.

13. The computer system of claim 11, wherein the multiple health care quality domains further comprise at least one of the following:
a member experience domain, from which a patient feedback quality score regarding quality of care by the health care provider is obtained;
at least one care prevention domain indicative of at least one of primary, secondary, or tertiary care prevention;
a continuity of care domain indicative of an extent to which an ongoing health care relationship is maintained between the health care provider and the member panel; or
a chronic-care and follow-up services domain indicative of an ability of the health care provider to provide chronic-care and follow-up services to the member panel.

14. The computer system of claim 13, wherein determining the quality scores comprises risk-adjusting quality scores of multiple domains of the member experience domain, at least one care prevention domain, continuity of care domain, or chronic care and follow-up services domain, wherein the risk-adjustment is performed against a peer reference base, and wherein the quality scores from which the composite health provider quality score is determined includes the risk-adjusted quality scores.

15. The computer system of claim 14, wherein the risk-adjustment is based, at least in part, on disease category, member age, and member sex of members of the member panel.

16. The computer system of claim 14, wherein the quality scores across the multiple health care quality domains are determined based at least partially on non-disease-specific health measures of the obtained health care claims data.

17. The computer system of claim 13, wherein the multiple health care quality domains comprise the continuity of care domain, and wherein determining the quality scores comprises risk-adjusting at least one quality score of the continuity of care domain based, at least in part, on member age, member sex, and member disease status of the member panel, wherein the risk-adjustment is performed against a peer reference base.

18. The computer system of claim 13, wherein the multiple health care quality domains comprise the continuity of care domain, wherein a quality score of the continuity of care domain, and wherein the health care provider comprises one or more primary care practitioners, and wherein a quality score of the continuity of care domain indicates continuity of care by the one or more primary care practitioners for the member panel and is further based, at least in part, on emergency room visits of the member panel.

19. The computer system of claim 11, wherein the multiple health care quality domains comprise the following health care quality domains:
a member experience domain, from which a patient feedback quality score regarding quality of care by the health care provider is obtained
at least one care prevention domain indicative of at least one of primary, secondary, or tertiary care prevention;
a continuity of care domain indicative of an extent to which an ongoing health care relationship is maintained between the health care provider and the member panel; and
a chronic-care and follow-up services domain indicative of an ability of the health care provider to provide chronic-care and follow-up services to the member panel.

20. A computer program product for evaluating health care provider quality, the computer program product comprising:
a tangible storage medium readable by a processor and storing instructions for execution to perform a method comprising:
obtaining data including health care claims data corresponding to health care claims by a member panel of a health care provider, the member panel comprising multiple patients to which the health care provider provides health care services;
determining, based at least partially on the obtained health care claims data, quality scores for the health care provider across the member panel and across multiple health care quality domains, wherein a health care quality domain of the multiple health care quality domains comprises a heath status domain, wherein a determined quality score of the health status domain comprises a measure of disease progression in members of the member panel of the health care provider; and
determining a composite health provider quality score of the health provider, the composite health provider quality score being a composite of the determined quality scores for the health care provider across the member panel and across the multiple health care quality domains.
